(19) United States
(12) Patent Application Publication
(10) Pub. No.: US 2026/0222600 A1
(43) Pub. Date: Jul. 30, 2026

(54) METHOD, DEVICE, AND RECORDING MEDIUM FOR ENCODING/DECODING IMAGES FOR MACHINES

(71) Applicants: Electronics and Telecommunications Research Institute, Daejeon (KR); UNIVERSITY-INDUSTRY COOPERATION GROUP OF KYUNG HEE UNIVERSITY, Yongin-si (KR)

(72) Inventors: Jin Young LEE, Daejeon (KR); Soon Heung JUNG, Daejeon (KR); Se Yoon JEONG, Daejeon (KR); Kyu Heon KIM, Yongin-si (KR); Seong Bae Rhee, Yongin-si (KR); Ki Beom PARK, Yongin-si (KR)

(73) Assignees: Electronics and Telecommunications Research Institute, Daejeon (KR); UNIVERSITY-INDUSTRY COOPERATION GROUP OF KYUNG HEE UNIVERSITY, Yongin-si (KR)

(21) Appl. No.: 19/450,877

(22) Filed: Jan. 16, 2026

(30) Foreign Application Priority Data
Jan. 17, 2025 (KR) 10-2025-0007580
Feb. 28, 2025 (KR) 10-2025-0027087
Jan. 15, 2026 (KR) 10-2026-0007821
Jan. 15, 2026 (KR) 10-2026-0007822

(51) Int. Cl. H04N 19/169; H04N 19/70

(52) U.S. Cl. CPC H04N 19/188; H04N 19/70

(57) ABSTRACT

A bitstream used by a method, a device and a recording medium for encoding/decoding an image based on a region of interest of the present disclosure includes at least one network abstraction layer (NAL) unit, and a header of the NAL unit may include index information specifying a type of an NAL unit.

### RELATED APPLICATION REFERENCE

This application claims the prior filing date and priority of Korean Patent Application No. 10-2025-0007580 filed on Jan. 17, 2025, Korean Patent Application No. 10-2025-0027087 filed on Feb. 28, 2025, Korean Patent Application No. 10-2026-0007821 filed on Jan. 15, 2026 and Korean Patent Application No. 10-2026-0007822 filed on Jan. 15, 2026, the contents of which are incorporated herein by reference.

### TECHNICAL FIELD

The present disclosure relates to a method, a device and a recording medium for encoding/decoding an image for machines.

### BACKGROUND ART

Conventionally, video encoding/decoding technologies have improved image compression efficiency and image quality by considering the human visual system. However, future image encoding/decoding technologies are expected to be widely utilized not only for human vision but also in machine vision fields such as surveillance, intelligent transportation, smart cities, intelligent industry, etc.

Accordingly, there is a need to develop an image encoding/decoding technology by which high-efficiency compression and recognition accuracy can be obtained by simultaneously considering human vision and machine vision.

### DISCLOSURE

### Technical Problem

The present disclosure aims to separate time, space, ROI and bit depth parameters into separate NAL unit types.

### Technical Solution

A bitstream used by a method, a device and a recording medium for encoding/decoding an image based on a region of interest of the present disclosure includes at least one network abstraction layer (NAL) unit, and a header of the NAL unit may include index information specifying a type of an NAL unit.

In a method, a device and a recording medium for encoding/decoding an image based on a region of interest of the present disclosure, the type of the NAL unit may be a type of one NAL unit specified by the index information among types of a plurality of NAL units included in a pre-defined table.

In a method, a device and a recording medium for encoding/decoding an image based on a region of interest of the present disclosure, the types of the plurality of NAL units may include a video parameter set (VPS), codec video data (CVD) and an end of bitstream (EOB).

In a method, a device and a recording medium for encoding/decoding an image based on a region of interest of the present disclosure, the types of the plurality of NAL units may include at least one of a spatial parameter set (SPS), a temporal parameter set (TPS), an Rol parameter set (RPS) and a bit-depth parameter set (BPS).

In a method, a device and a recording medium for encoding/decoding an image based on a region of interest of the present disclosure, an NAL unit in which the type of the NAL unit is the SPS may include an SPS raw byte sequence payload (RBSP).

In a method, a device and a recording medium for encoding/decoding an image based on a region of interest of the present disclosure, an NAL unit in which the type of the NAL unit is the TPS may include a TPS raw byte sequence payload (RBSP).

In a method, a device and a recording medium for encoding/decoding an image based on a region of interest of the present disclosure, a syntax structure of the TPS RBSP may not include a flag for activating the TPS.

### Technical Effect

The present disclosure may improve encoding/decoding efficiency by separating temporal, spatial, ROI and bit depth parameters into separate NAL unit types.

### BRIEF DESCRIPTION OF DRAWINGS

FIG. 1 is a block diagram of an image encoder according to an embodiment of the present disclosure

FIG. 2 is a block diagram of an image decoder according to an embodiment of the present disclosure

FIG. 3 illustrates the bitstream structure of VCM.

FIG. 4 illustrates an example of a bitstream structure.

FIG. 5 illustrates an example of a general NAL unit syntax.

FIG. 6 illustrates an example of a VCM NAL unit header syntax.

FIG. 7 illustrates an example of a table for pre-defining the type of a VCM NAL unit.

FIG. 8 illustrates an example of a video parameter set RBSP syntax.

FIG. 9 illustrates an example of a syntax regarding a profile tier level.

FIG. 10 illustrates an example of a temporal parameter set RBSP syntax.

FIG. 11 illustrates an example of a spatial parameter set RBSP syntax.

FIG. 12 illustrates an example of an ROI parameter set RBSP syntax.

FIG. 13 illustrates an example of the index of an Rol scaling factor for a numerator and a denominator.

FIG. 14 illustrates an example of a bit depth parameter set RBSP syntax.

FIG. 15 illustrates an example of a supplemental enhancement information RBSP syntax.

FIG. 16 illustrates an example of a supplemental enhancement information message syntax.

FIG. 17 illustrates an example of an RBSP trailing bits syntax.

FIG. 18 illustrates an example of a byte alignment syntax.

FIG. 19 illustrates an example of a codec video data syntax.

FIGS. 20 to 22 illustrate an example of the number of bytes of a bitstream structure in the first embodiment.

FIG. 23 illustrates an example of the number of bytes of a bitstream structure in the second embodiment.

### MODE FOR INVENTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in the idea and technical scope of the present disclosure. A similar reference numeral in a drawing refers to a like or similar function across multiple aspects. The shape and size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented as another embodiment without departing from the scope and spirit of the present disclosure in connection with an embodiment. In addition, it should be understood that the position or arrangement of an individual component in each disclosed embodiment may be changed without departing from the scope and spirit of an embodiment. Accordingly, a detailed description described below is not taken as a limited meaning and the scope of exemplary embodiments, if properly described, is limited only by an accompanying claim along with any scope equivalent to that claimed by those claims.

In the present disclosure, a term such as first, second, etc. may be used to describe a variety of components, but the components should not be limited by the terms. The terms are used only to distinguish one component from other components. For example, without departing from the scope of a right of the present disclosure, the first component may be referred to as the second component and likewise, the second component may be also referred to as the first element. A term of and/or includes a combination of a plurality of relevant described items or any of a plurality of relevant described items.

When a component in the present disclosure is referred to as being “linked” or “connected” to another component, it should be understood that it may be directly linked or connected to that another component, but another component may exist in the middle. On the other hand, when a component is referred to as being “directly linked” or “directly connected” to another component, it should be understood that another component does not exist in the middle.

As construction units shown in the embodiment of the present disclosure are independently shown to represent different characteristic functions, it does not mean that each construction unit is constructed in the construction unit of separate hardware or one software. In other words, as each construction unit is included by being enumerated as each construction unit for convenience of description, at least two construction units of each construction unit may be combined to form one construction unit or one construction unit may be divided into a plurality of construction units to perform a function, and the integrated embodiment and separate embodiment of each construction unit are also included in the scope of a right of the present disclosure unless they are beyond the essence of the present disclosure.

As a term used in the present specification is just used to describe a specific embodiment, it is not intended to limit the present disclosure. Expression of the singular includes expression of the plural unless it clearly has a different meaning contextually. In the present disclosure, it should be understood that a term such as “include” or “have”, etc. is to designate the existence of features, numbers, steps, motions, components, parts or combinations thereof described on the specification, but is not to exclude the existence or possibility of addition of one or more other features, numbers, steps, motions, components, parts or combinations thereof in advance. In other words, a description of “including” a specific configuration in the present disclosure does not exclude a configuration other than a corresponding configuration, and it means that an additional configuration may be included in the scope of a technical idea of the present disclosure or the embodiment of the present disclosure.

Some components of the present disclosure are not a necessary component which performs an essential function in the present disclosure and may be an optional component just for improving performance. The present disclosure may be implemented by including only a construction unit which is necessary to implement essence of the present disclosure except for a component used just for performance improvement, and a structure including only a necessary component except for an optional component used just for performance improvement is also included in the scope of a right of the present disclosure.

Hereinafter, the embodiment of the present disclosure will be described in detail by referring to drawings. In describing the embodiment of the present specification, when it is determined that a detailed description on a relevant disclosed construction or function may obscure the gist of the present specification, such a detailed description is omitted, and the same reference numeral is used for the same component on a drawing and an overlapping description on the same component is omitted.

In the present disclosure, unlike the existing VCM structure, functions may be expanded by defining the class of a VCM-dedicated NAL unit type.

In addition, the present disclosure discloses the improved bitstream of VCM, an NAL sample stream structure and an NAL unit type class structure.

In addition, the present disclosure separates SRD and PRD parameters within an RSD sample stream in an NAL form for time, space, an ROI and a bit depth and removes and reconfigures a redundant parameter to optimize the size of a VCM bitstream.

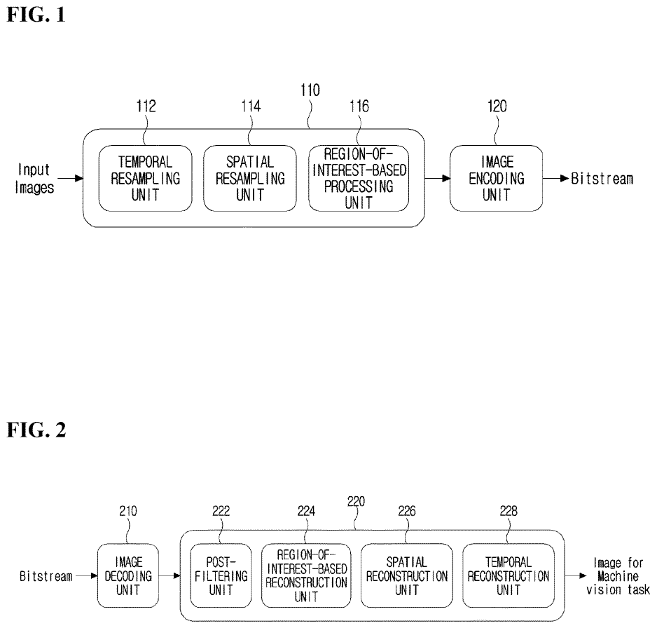

FIG. 1 is a block diagram of an image encoder according to an embodiment of the present disclosure Referring to FIG. 1, an image encoder may include the preprocessing unit 110 and the image encoding unit 120.

The preprocessing unit 110 performs a preprocessing process to convert input original images into images suitable for image encoding. Here, images input to the preprocessing unit 110 may be color or black-and-white images conforming to the YUV or YCbCr format.

The preprocessing unit 110 may include at least one of the temporal resampling unit 112, the spatial resampling unit 114 or the region-of-interest-based processing unit 116.

The temporal resampling unit 112 temporally resamples images. Only resampled images may be selected for image encoding. In other words, encoding of some of the images input to the preprocessing unit 110 may be omitted through temporal resampling. For example, a 60 fps (frame per second) image may be converted into a 30 fps image by omitting odd-numbered images of the 60 fps image. Alternatively, images in a specific output order may be omitted by considering temporal redundancy between images.

The spatial resampling unit 114 spatially resamples an image. The size and/or spatial resolution of an image may be reduced through spatial resampling. For example, an image with a resolution of 1920×1080 may be converted to an image with a resolution of 960×540 or 480×270.

The region-of-interest-based processing unit 116 sets a region of interest within an image such that image encoding/decoding is performed focusing on information important to machine inference tasks. The region-of-interest-based processing unit 116 may remove a background region excluding a set region of interest or adjust the size and/or position of a region of interest within an image, so that a region of interest is set to be encoded/decoded with high quality.

The image encoding unit 120 may encode an image output from the preprocessing unit 110. Meanwhile, the image encoding unit 120 may encode an image by utilizing typical codec technologies or codec technologies modified for video coding for machine (VCM) based on typical codec technologies. As an example, the image encoding unit 120 may encode an image based on HEVC, VVC or AV1. As a result of image encoding, a bitstream is generated and a generated bitstream may be transmitted to an image decoder.

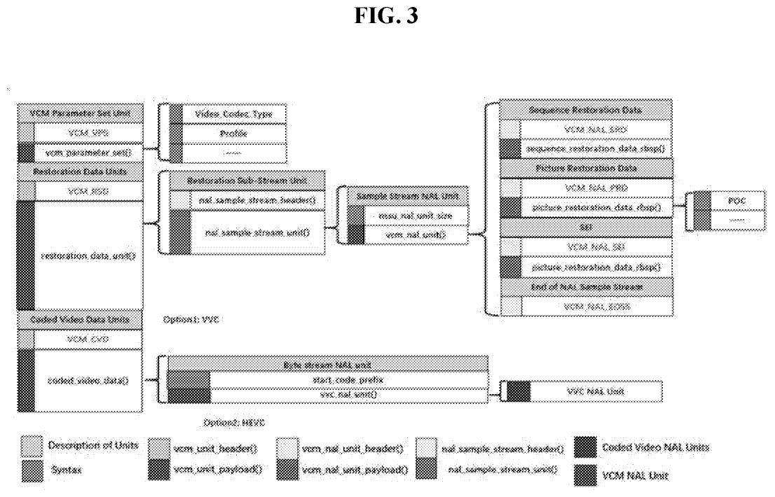

FIG. 2 is a block diagram of an image decoder according to an embodiment of the present disclosure

Referring to FIG. 2, an image decoder may include the image decoding unit 210 and the post-processing unit 220.

The image decoding unit 210 decodes a bitstream received from the image encoding unit 110 to generate a decoded or reconstructed image. The image decoding unit 210 may decode a bitstream based on a codec technology used in the image encoding unit 120.

The post-processing unit 220 performs post-processing on a decoded image. Through post-processing, the size and frame rate of an image may be restored to match an original image.

The post-processing unit 220 may include at least one of the post-filtering unit 222, the region-of-interest-based reconstruction unit 224, the spatial reconstruction unit 226 or the temporal reconstruction unit 218.

The post-filtering unit 222 applies filtering to reduce the reconstruction error of a decoded image. As an example, the post-filtering unit 222 may apply an in-loop filter to a decoded image. An in-loop filter may include at least one of a deblocking filter, a sample adaptive offset filter, a luma mapping chroma scaling (LMCS) filter or an adaptive loop filter.

The region-of-interest-based reconstruction unit 224 obtains an image of the same size as an original image based on region-of-interest information. As an example, when a cropped image is encoded such that a region of interest is included therein, a decoded image has a different size from an original image. Accordingly, the region-of-interest-based reconstruction unit may adjust a retargeted image to an original size. Here, a retargeted image may represent a decoded image or an image on which upscaling is performed through the spatial reconstruction unit 226. Alternatively, when the size or position of a region of interest within an encoding target image is adjusted, the region-of-interest-based reconstruction unit 224 may adjust the position and size of a region of interest within a retargeted image to match an original image.

The spatial reconstruction unit 226 performs upscaling on a decoded image. A decoded image may be reconstructed to be an image having the same size and/or spatial resolution as an original image through upscaling.

The temporal reconstruction unit 228 reconstructs an image at a temporal position where encoding/decoding is omitted through temporal resampling. Specifically, the temporal reconstruction unit 228 may generate an image at a temporal position where encoding/decoding is omitted through interpolation between decoded images.

Meanwhile, in order to perform reverse processing on image processing performed in the preprocessing unit 110, additional information may be encoded and signaled. The post-processing unit 220 may perform post-processing on a decoded image based on the additional information to generate an image for machine inference. Meanwhile, additional information may be referred to as ‘metadata’.

Metadata may include at least one of temporal resampling information, spatial resampling information or region-of-interest processing information.

Temporal resampling information may include at least one of a flag representing whether temporal resampling is performed or information representing a temporal resampling rate.

As an example, when the flag is 1, it represents that temporal resampling is performed. In this case, information representing a temporal resampling rate may be additionally encoded/decoded. When temporal resampling is performed, fewer images than the number of original images may be encoded/decoded. An image decoder may reconstruct an image on which encoding/decoding is omitted through temporal reconstruction.

On the other hand, when the flag is 0, it represents that temporal resampling is not performed.

A temporal resampling rate may be expressed as an exponent of 2. As an example, a temporal resampling rate of 2\hat{ }N represents that one of 2\hat{ }N images is selected as an encoding/decoding target image. For example, only images having a picture order count (POC) of a multiple of 2\hat{ }N may be encoded/decoded. Information representing a temporal resampling rate may represent the exponent (i.e., N) of a temporal resampling rate. As an example, the information may represent the exponent value of a temporal resampling rate or a value obtained by subtracting 1 from an exponent value.

Spatial resampling information may include at least one of a flag representing whether spatial resampling is performed or information representing a scaling parameter for spatial resampling

As an example, when the flag is 1, it represents that spatial resampling is performed. In this case, information representing a scaling parameter may be additionally encoded. Specifically, information representing a horizontal scaling parameter and information representing a vertical scaling parameter may be encoded and signaled, respectively. When spatial resampling is performed, the size and/or spatial resolution of an image may be reduced. An image decoder may reconstruct the size of a decoded image to the size of an original image or a pre-set size through spatial reconstruction. Meanwhile, information for designating a pre-set size may be additionally encoded/decoded.

When the flag is 0, it represents that spatial resampling is not performed.

Region-of-interest processing information may include at least one of image size information or region-of-interest information.

Image size information may include information representing whether retargeting is performed. When a retargeting flag is 1, it represents that a retargeted image is encoded/decoded instead of an original image. On the other hand, when a retargeting flag is 0, it represents that an original image is encoded/decoded as is.

A retargeted image represents an image generated by performing at least one of resolution adjustment and position adjustment on at least one region of interest within an original image. Accordingly, the resolution or position of a region of interest within a retargeted image may be different from that of an original image. In addition, the size of a retargeted image may be the same as or smaller than that of an original image.

When retargeting is allowed (i.e., when a retargeting flag is 1), the size information of a retargeted image may be encoded/decoded. The size information of a retargeted image may include the width information of an image and the height information of an image.

Meanwhile, information representing a size difference between an original image and a retargeted image may be additionally encoded/decoded. As an example, information representing whether a difference between the size of a retargeted image and the size of an original image is encoded/decoded may be encoded/decoded.

As an example, when information representing whether a size difference is encoded/decoded is 0, it represents that a size difference between a retargeted image and an original image is not encoded/decoded.

On the other hand, when information representing whether a size difference is encoded/decoded is 1, it represents that a size difference between a retargeted image and an original image is encoded/decoded. In this case, information representing a difference between the size of a retargeted image and the size of an original image may be additionally encoded/decoded.

Information representing a size difference represents a size difference between an original image and a retargeted image. Meanwhile, information representing a horizontal size difference and information representing a horizontal size difference may be encoded and signaled, respectively.

Region-of-interest information may include at least one of a flag indicating whether a region of interest is present, information on the number of regions of interest, the scaling parameter of a region of interest or the position information of a region of interest.

As an example, when the flag is 1, it represents that information about a region of interest is encoded/decoded. In this case, at least one of the number of regions of interest, scaling parameter information of a region of interest, position information of a region of interest or size information of a region of interest may be additionally encoded/decoded.

On the other hand, when the flag is 0, it represents that a region of interest is not present.

Information about the number of regions of interest represents the number of regions of interest. Meanwhile, the number of regions of interest may be calculated in the unit of an image group including at least one image.

The scaling parameter of a region of interest represents a scaling parameter for a region of interest. According to the scaling parameter of a region of interest, the size of a region of interest may be adjusted.

Scaling parameter information of a region of interest may include information representing whether the scaling parameter of a region of interest is updated. When information representing whether a region of interest is updated represents that the scaling parameter of a region of interest is not updated, the scaling parameter of a region of interest may be set as a default value or the same value as in a previous frame. On the other hand, when information representing whether a region of interest is updated represents that the scaling parameter of a region of interest needs to be updated, information representing the scaling parameter of a region of interest may be additionally encoded/decoded.

Meanwhile, the scaling parameter information of a region of interest may be encoded/decoded individually for each region of interest.

Position information of a region of interest represents the position of a region of interest in an original image. In this case, the horizontal position (i.e., x-axis coordinate) information and vertical position (i.e., y-axis coordinate) information of a region of interest may be encoded/decoded, respectively.

Size information of a region of interest represents the size of a region of interest in an original image. In this case, the horizontal size (i.e., width) information and vertical size (i.e., height) information of a region of interest may be encoded/decoded, respectively.

As described above, according to the present disclosure, through the preprocessing process of an image, the encoding/decoding efficiency of an image may be improved while maintaining machine task performance.

RBSP in the present disclosure may be an abbreviation for Raw Byte Sequence Payload.

VCM in the present disclosure may be an abbreviation for Video Coding for Machines.

NAL in the present disclosure may be an abbreviation for Network Abstraction Layer.

NUT in the present disclosure may be an abbreviation for NAL Unit Type.

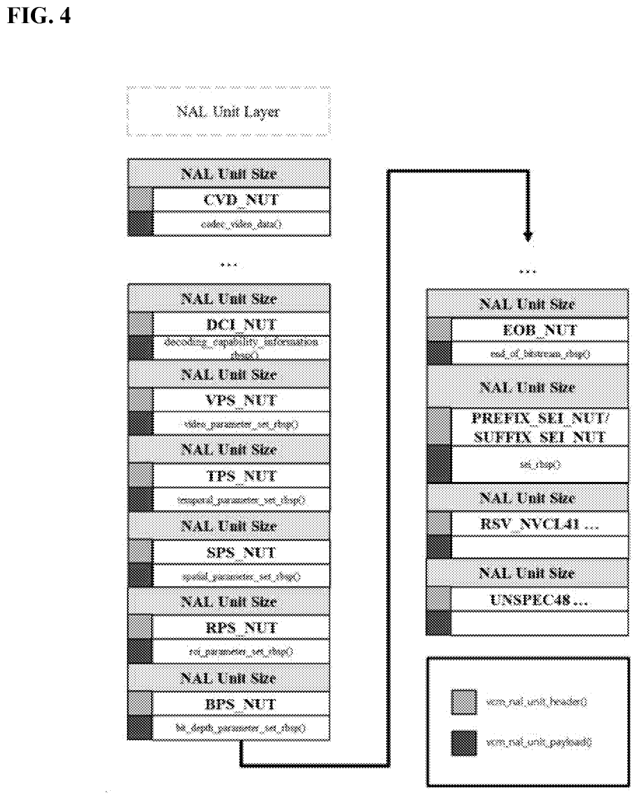

FIG. 3 illustrates the bitstream structure of VCM.

Referring to FIG. 3, the bitstream structure of VCM may consist of a VCM unit, an NAL sample stream, an NAL unit step and a reconstruction data NAL unit.

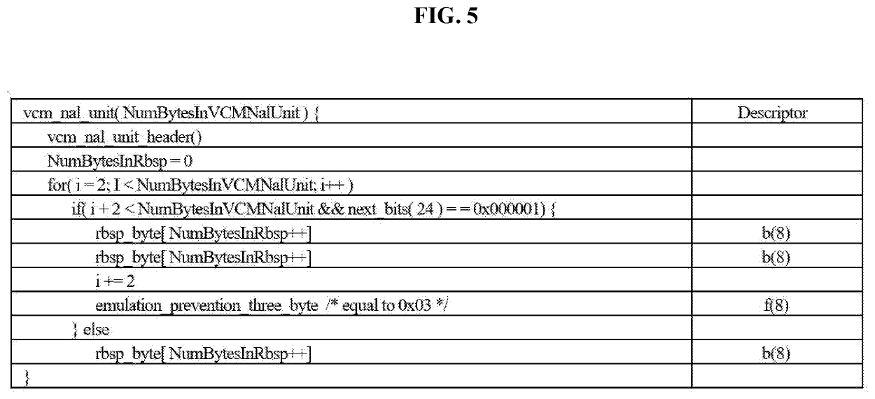

FIG. 4 illustrates an example of a bitstream structure.

Referring to FIG. 4, vcm_nal_unit_header may specify the type of a VCM NAL unit. An NUT in FIG. 4 may refer to Nal Unit Type. In other words, the type of a VCM NAL unit specified by vcm_nal_unit_header may include a VCM parameter set (VPS), coded video data (CVD), an end of bitstream (EOB), etc. Additionally, it may also include decoding capability information (DCI), a temporal parameter set (TPS), a spatial parameter set (SPS), an Rol parameter set (RPS), a bit-depth parameter set (BPS), etc.

According to the type of a VCM NAL unit specified by vcm_nal_unit_header, a syntax element included in vcm_nal_unit_payload may be different. As an example, when the type of a VCM NAL unit is VCM, vcm_nal_unit_payload may include vcm_parameter_set( ). As an example, when the type of a VCM NAL unit is CVD, vcm_nal_unit_payload may include coded_video_data( ). As an example, when the type of a VCM NAL unit is EOB, vcm_nal_unit_payload may include end_of_bitstream( ). In addition, examples illustrated in FIG. 4 may be included.

As an embodiment, as in FIG. 4, temporal, spatial, ROI and bit-depth parameters may be separated from SRD and PRD and reconfigured. As another embodiment, temporal, spatial, ROI and bit-depth parameters may be included in SRD and PRD and configured.

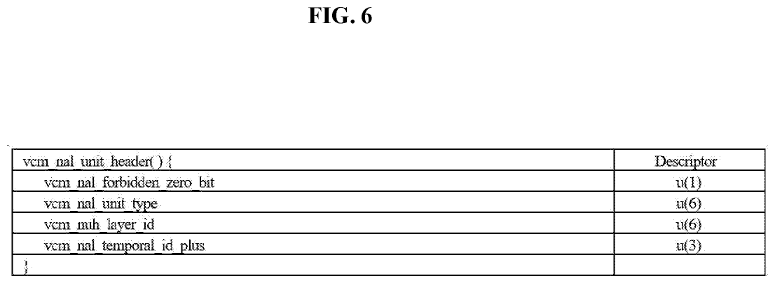

FIG. 5 illustrates an example of a general NAL unit syntax.

A VCM NAL Unit syntax structure calls a VCM NAL unit header, and the number of bytes in a VCM NAL unit may be used.

numByteslnVCMNalUnit designates the size of a VCM NAL unit in the unit of a byte. This value may be required for NAL unit decoding.

numByteslnVCMNalUnit may be inferred by a method for dividing an NAL unit boundary.

One of these boundary division methods may be specified in Appendix C for an NAL sample stream format. In addition, other boundary division methods may be used.

A recovery data coding layer (RCL) may be designed to efficiently express the contents of recovery data.

A VCM NAL may be specified to format data and provide header information in a manner suitable for transmission through various communication channels or storage media. All data is included in a VCM NAL unit, and each unit may have an integer number of bytes.

A VCM NAL unit may designate a general format that may be used in both a packet-oriented system and a bitstream system.

The format of a VCM NAL unit used in both packet-oriented transmission and NAL sample streams may be the same. However, in an NAL sample stream format specified in Appendix C, each NAL unit may be preceded by an additional element designating the size of a VCM NAL unit.

rbsp_byte[i] may be the i-th byte of an RBSP. An RBSP may be designated as a byte sequence listed in order as follows.

An RBSP may include the following data bit string (SODB).
When SODB is empty (i.e., when the length is 0 bits), an RBSP may also be empty.
Otherwise, an RBSP may include the following SODB.
   1) The first byte of an RBSP may include the first (most significant, leftmost) 8 bits of SODB. The next byte of an RBSP may include the next 8 bits of SODB, and this process may be repeated until the remaining bits of SODB is less than 8 bits.
   2) An rbsp_trailing_bits( ) syntax structure may be represented as follows after SODB.
      i) The first (most significant, leftmost) bit of the last RBSP byte may include the remaining bits of SODB (if any).
      ii) The next bit may be a single bit consisting of 1 bits (i.e., rbsp_stop_one_bit).
      iii) When rbsp_stop_one_bit is not the last bit of a byte-aligned byte, one or more 0 bits (i.e., rbsp_alignment_zero_bit) may be present to perform byte alignment.

A syntax structure with this RBSP attribute may be indicated by using the “_rbsp” suffix in a syntax table. This structure may be delivered as the contents of an rbsp_byte[i]data byte within a VCM NAL unit.

When knowing the boundary of an RBSP, a decoder may extract SODB from an RBSP by connecting the byte bits of an RBSP, discarding the last (least significant, rightmost) bit, rbsp_stop_one_bit (1), and discarding the following (lower, further to the right) bit (0).

Data needed for a decoding process may be included in the SODB part of an RBSP.

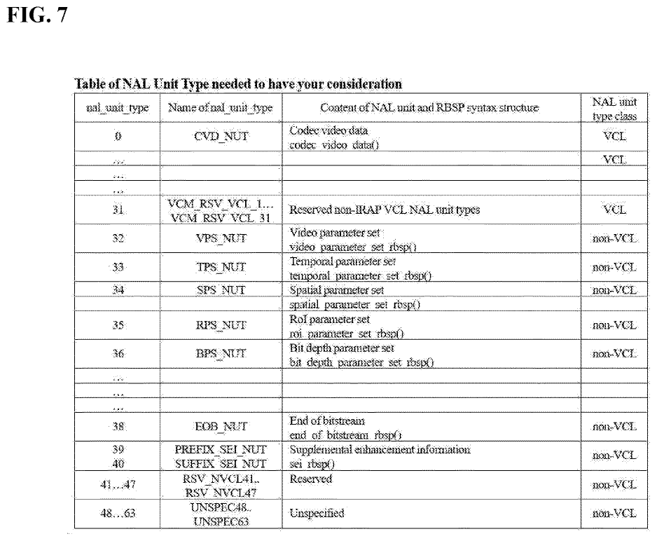

FIG. 6 illustrates an example of a VCM NAL unit header syntax.

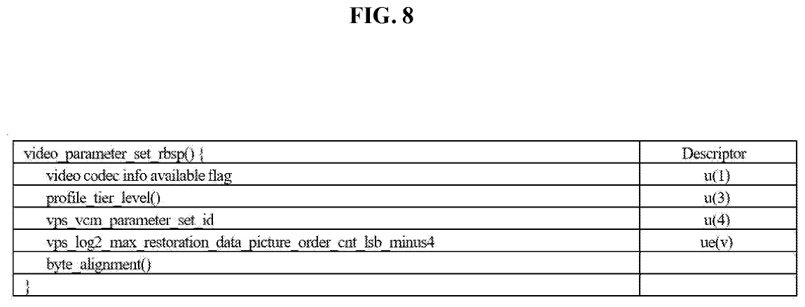

FIG. 7 illustrates an example of a table for pre-defining the type of a VCM NAL unit.

vcm_nal_unit_type may specify the VCM NAL unit type of a pre-defined table (see FIG. 7). As an embodiment, as in FIG. 4, when temporal, spatial, ROI and bit-depth parameters are separated from SRD and PRD and reconfigured, a VCM NAL unit type may include the type of the corresponding parameters (e.g., a TPS, an SPS, etc.).

vcm_nuh_layer_id may specify the id value of an NAL unit in the NAL unit layer of VCM.

vcm_nal_temporal_id_plus designates a temporal identifier for a VCM NAL unit.

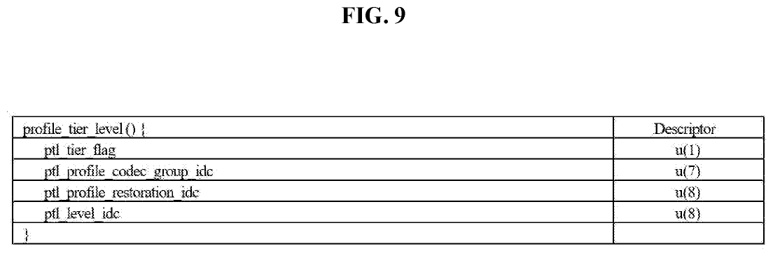

FIG. 8 illustrates an example of a video parameter set RBSP syntax.

A video codec info available flag may indicate whether codec information is available.

vps_vcm_parameter_set_id may provide an identifier for a VCM VPS for reference in other syntax elements. A vps_vcm_parameter_set_id value may be between 0 and 15.

A value obtained by adding 4 in vps_log2_max_restoration_data_picture_order_cnt_Isb_minus4 may designate the values of variables Log2MaxRestorationDataPicOrderCntLsb and MaxRestorationDataPicOrderCntLsb used in a decoding process for the picture order count (POC) of reconstruction data as follows.

$$Log 2 Max RestorationDataPicOrderCntLsb = vps\_log 2 \_max \_restoration \_data \_picture \_order \_cnt \_lsb \_minus4 + 4$$

MaxRestorationDataPicOrderCntLsb=2 Log2MaxRestorationDataPicOrderCntLsb

The value of vps_log2_max_restoration_data_picture_order_cnt_Isb_minus4 may be between 0 and 12.

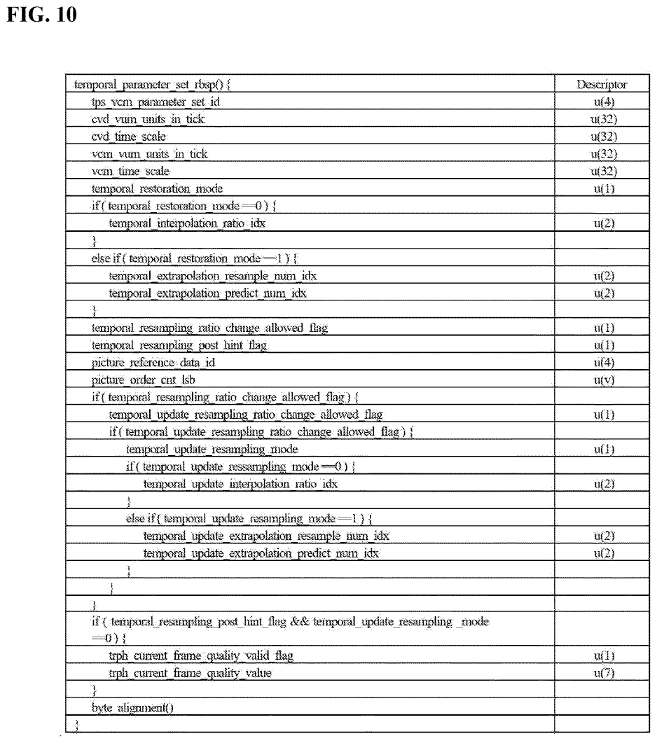

FIG. 9 illustrates an example of a syntax regarding a profile tier level.

ptl_tier_flag may be a flag designating a profile tier.

ptl_profile_codec_group_idc may represent a codec group profile component to which coded video data conforms.

ptl_profile_restoration_idc may represent a VCM toolset combination profile component to which a VCM bitstream conforms.

ptl_level_idc may represent a level to which a VCM bitstream must conform.

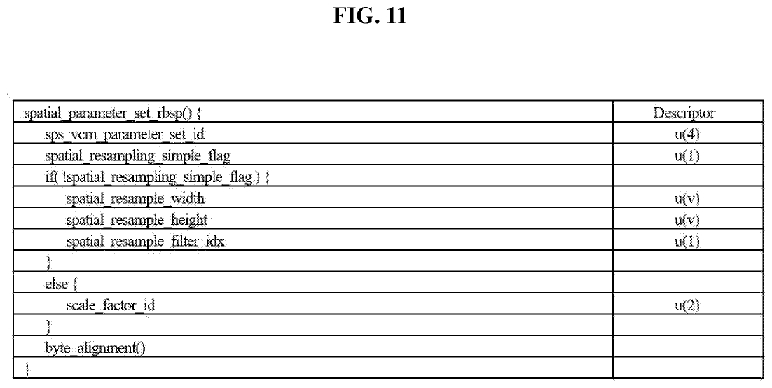

FIG. 10 illustrates an example of a temporal parameter set RBSP syntax.

tps_vcm_parameter_set_id may provide an identifier for a temporal parameter set for reference in other syntax elements.

cvd_num_units_in_tick may represent the number of time units corresponding to one increase (clock tick) of the clock tick counter of coded video data. This clock tick may operate at a frequency of time_scale Hz. num_units_in_tick may need to be greater than 0. A clock tick is calculated in seconds and may be a value obtained by dividing num_units_in_tick by time_scale. For example, when the image transmission rate of a video signal is 25 Hz, time_scale and num_units_in_tick may be 27,000,000 and 1,080,000, respectively, and accordingly, a clock tick may be 0.04 seconds.

cvd_time_scale may represent the number of time units that elapse in one second in coded video data. For example, the time_scale of a time coordinate system measuring time by using a 27 MHz clock is 27,000,000. The value of time_scale may need to be greater than 0.

vcm_num_units_in_tick is the number of time units of a clock operating at a frequency of time_scale Hz, which may correspond to one increase (referred to as a clock tick) of the clock tick counter of a VCM output. num_units_in_tick may need to be greater than 0. A clock tick may be the same as a value obtained by dividing num_units_in_tick by time_scale in seconds. For example, when the screen display rate of a video signal is 25 Hz, time_scale and num_units_in_tick may be 27,000,000 and 1,080,000, respectively, and accordingly, a clock tick may be 0.04 seconds.

vcm_time_scale may be the number of time units that elapse in one second in a VCM output. For example, the time_scale of a time coordinate system measuring time by using a 27 MHz clock may be 27,000,000. The value of time_scale may need to be greater than 0.

When temporal_restoration_mode is 0, it may represent that temporal restoration is activated in an interpolation mode, and when temporal_restoration_mode is 1, it may represent that temporal restoration is activated in an extrapolation mode.

temporal_interpolation_ratio_idx may be used to derive a global temporal interpolation ratio variable, TemporalInterpolationRatio.

When temporal_restoration_mode is 0, TemporalInterpolationRatio may be derived as follows.

srdTemporalInterpolationResamplingRatio=2temporal_interpolation_ratio_idx+1

The range of temporal_interpolation_ratio_idx may be from 0 to 2.

temporal_extrapolation_resample_num_idx may designate a value used to determine the number of frames to be used to perform temporal extrapolation. When temporal_restoration_mode is equal to 1, a global temporal extrapolation resampling number variable, TemporalExtrapolationResampleNum, may be initialized as follows.

TemporalExtrapolationResampleNum=temporal_extrapolation_resample_num_idx+2

The range of temporal_extrapolation_resampling_num_idx may be from 0 to 1.

temporal_extrapolation_predict_num_idx may designate a value used to determine the number of frames extrapolated in temporal extrapolation. When temporal_restoration_mode is equal to 1, a global temporal extrapolation prediction number variable, TemporalExtrapolationPredictNum, may be initialized as follows.

TemporalExtrapolationPredictNum=temporal_extrapolation_predict_num_idx+1

The range of temporal_extrapolation_predict_num_idx may be from 0 to 2.

When the value of temporal_resampling_ratio_change_allowed_flag is 1, it may designate that an image level temporal resampling ratio may be used, and when the flag value is 0, it may designate that an image level temporal resampling ratio must not be used.

When the value of temporal_resampling_post_hint flag is 1, a temporal resampling post-processing hint may be activated, and when the flag value is 0, a temporal resampling post-processing hint may be deactivated.

```
  picture_reference_data_id may be the same as tps_vcm_parameter_set_id.
  picture_order_cnt_lsb may be the same as
vps_log2_max_restoration_data_picture_order_cnt_lsb_minus4.
```

When the value of temporal_update_resampling_ratio_changed_flag is 1, it may represent that a current temporal resampling ratio is changed and at least one of 1) a temporal restoration mode, 2) a temporal interpolation ratio or 3) the number of temporal extrapolation resamplings or the number of current temporal extrapolation predictions is modified. In this case, temporal restoration may be performed by using a changed parameter. When the flag value is 0, it may represent that the temporal restoration parameter of a current picture is the same as that of a previous picture.

temporal_update_restoration_mode may be used to derive the temporal restoration mode of a current (i-th) picture.

$$TemporalRestorationMode [ i ] = temporal\_update \_restoration \_mode$$

If a previous temporal restoration mode TemporalRestorationMode[i−1] is 0 and a current temporal restoration mode TemporalRestorationMode[i] is 1, a current picture may correspond to an input to both a temporal interpolation input and a temporal extrapolation input.

If temporal_update_resampling_ratio_changed_flag is equal to 1, a global variable TemporalRestorationMode may be updated to TemporalRestorationMode[i].

Otherwise, TemporalRestorationMode is not changed and may be maintained to be the same as the temporal restoration mode of a previous picture.

When a previous temporal restoration mode is 0 and a current picture is not the first temporal resampling picture, a temporal interpolation process may be called by using the (i−1)th picture, a current i-th picture and a previous temporal interpolation ratio TemporalInterpolationRatio[i−1](when TemporalInterpolationRatio[i−1] is not 1) as an input.

When a current temporal restoration mode (TemporalRestorationMode[i]) is 1 and a current temporal extrapolation prediction number (TemporalExtrapolationPredictNum[i]) is not 0, a current i-th picture may be added to a reference list. When the length of a reference list reaches a reference list ResampleNum[i], a temporal extrapolation process may be called by using a reference list and TemporalExtrapolationPredictNum[i] as an input.

$$TemporalResamplingRatio [ PicOrderCntVal ( currPic ] = temporal\_update \_resampling \_ratio \_changed \_ flag ? prdTemporalResamplingRatio : srdTemporalResamplingRatio$$

Here, currPic may be a current picture corresponding to current PRD. TemporalResamplingRatio[PicOrderCntVal(currPic)] may represent the number of pictures that must be interpolated between currPic and a restored picture. In this case, PicOrderCntVal(may be the same as PicOrderCntVal(currPic)+1 (when a corresponding picture exists).

temporal_update_interpolation_ratio_idx may be used to derive a temporal interpolation ratio. TemporalUpdateResamplingRatio may be as follows.

$$TemporalUpdateInterpolationRatio = 2 temporal\_update \_interpolation \_ratio \_idx$$

The range of temporal_update_resampling_ratio_idx may be from 0 to 3.

When temporal_update_resampling_ratio_changed is 1 and temporal_update_restoration_mode is 0, a global variable TemporalInterpolationRatio may be updated to TemporalInterpolationRatio[i]. Otherwise, TemporalInterpolationRatio is not changed and may be maintained to be the same as the temporal interpolation ratio of a previous picture.

When temporal_update_interpolation_ratio_idx is 0, a current temporal interpolation process may not be performed.

Temporal_update_extrapolation_resample_num_idx may be used to derive the temporal extrapolation resampling number of a current picture as follows.

$$TemporalExtrapolationResampleNum [ i ] = temporal\_update \_extrapolation \_resample \_num \_idx + 2$$

When temporal_update_resampling_ratio_changed is 1 and temporal_update_restoration_mode is 1, a global variable TemporalExtrapolationResampleNum may be updated to TemporalExtrapolationResampleNum[i]. Otherwise, TemporalExtrapolationResampleNum is not changed and may be maintained to be the same as the temporal extrapolation resampling number of a previous picture. The range of temporal_update_extrapolation_resample_num_idx may be from 0 to 1.

Temporal_update_extrapolation_predict_num_idx may be used to derive the temporal extrapolation prediction number of a current picture as follows.

$$TemporalExtrapolationPredictNum [ i ] = temporal\_update \_extrapolation \_predict \_num \_idx$$

When temporal_update_resampling_ratio_changed is 1 and temporal_update_restoration_mode is 1, a global variable TemporalExtrapolationRatio may be updated to TemporalExtrapolationPredictNum[i]. Otherwise, TemporalExtrapolationRatio is not changed and may be maintained to be the same as the temporal extrapolation prediction number of a previous picture.

The range of temporal_update_extrapolation_predict_num_idx may be from 0 to 3.

When temporal_update_extrapolation_predict_num_idx is 0, a current temporal extrapolation process may not be performed.

erd_num_temporal_remain designates the number of pictures aligned after a previous temporal resampling picture when vps_temporal_restoration_flag is 1 and temporal_restoration_flag is 1. The range of erd_num_temporal_remain may be from 0 to the number of pictures generated from previous temporal restoration.

When the value of temporal_update_resampling_post_hint flag is 1, a temporal resampling post-processing hint may be activated.

When the value of temporal_update_resampling_post_hint flag is 0, a temporal resampling post-processing hint may be deactivated.

When trph_current_frame_quality_valid_flag is 1, it may represent that a current frame may apply post-filtering according to trph_current_frame_quality_value. When trph_current_frame_quality_valid_flag is 0, it may represent that the trph_current_frame_quality_value of a current frame is not valid for post-filtering. trph_current_frame_quality_valid_flag may be updated to 0 or 1 according to an ROI ratio during Rol processing.

trph_current_frame_quality_value may designate a non-reference picture quality assessment score for a frame interpolated through temporal resampling.

A trph_current_frame_quality_value value may range from 0 to 127.

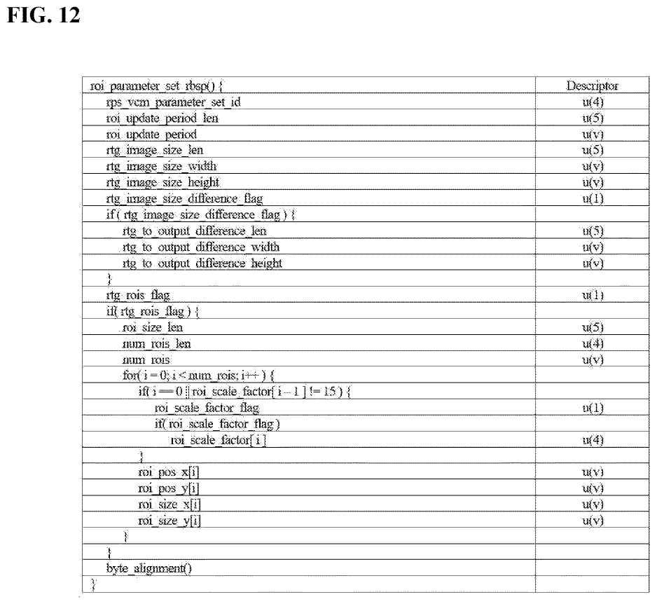

FIG. 11 illustrates an example of a spatial parameter set RBSP syntax.

sps_vcm_parameter_set_id may provide an identifier for a spatial parameter set for reference in other syntax elements.

spatial_resampling_simple_flag may represent whether a simple spatial resampling restoration process is performed.

spatial_resample_width may designate the width of a resampled picture.

spatial_resample_height may designate the height of a resampled picture.

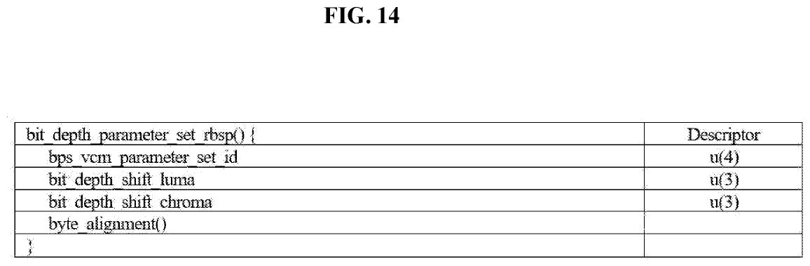

spatial_resample_filter_idx may represent a spatial resampling filter index used to designate a spatial resampling filter in a decoder, as defined in Table 1 (FIG. 13).

scale_factor_id may represent a scale factor identifier.

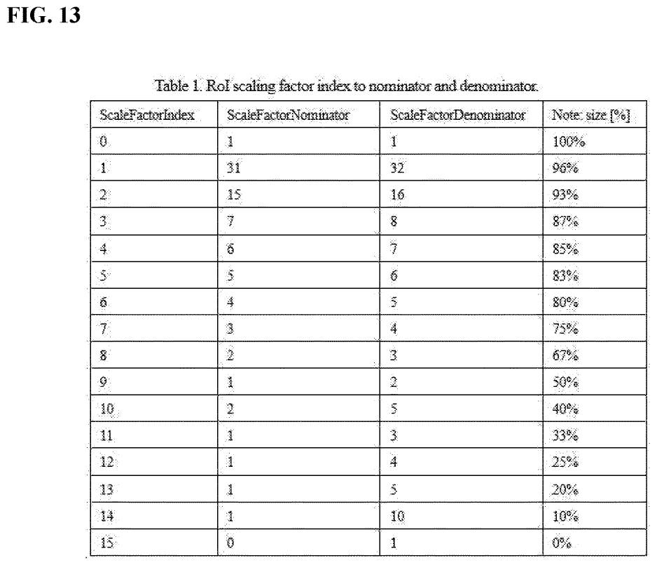

FIG. 12 illustrates an example of an ROI parameter set RBSP syntax.

rps_vcm_parameter_set_id may provide an identifier for an ROI parameter set for reference in other syntax elements.

roi_update_period_len may represent the bit length of an ROI update period.

roi_update_period may represent the frequency of updating ROI information. roi_update_period may be a group of pictures (GOP) or a specific time unit.

rtg_image_size_len may designate the number of bits used to represent rtg_image_size_width and rtg_image_size_height.

rtg_image_size_width and rtg_image_size_height may designate the width and height of an internal decoded image, respectively.

The length of rtg_image_size_width and rtg_image_size_height syntax elements may be an rtg_image_size_len bit, respectively.

When the value of rtg_image_size_difference_flag is 1, it may represent that the size of a picture output from picture retargeting is signaled, and when the value is 0, it may represent that the size of a picture output from picture retargeting is the same as the size of a picture input to picture retargeting.

rtg_to_output_difference_len may designate the number of bits used to represent rtg_to_output_difference_width and rtg_to_output_difference_height.

rtg_to_output_difference_width and rtg_to_output_difference_height may designate a difference between the output image size of picture retargeting and an internal decoded image size. The length of rtg_to_output_difference_width and rtg_to_output_difference_height syntax elements may be an rtg_to_output_difference_len, respectively. When rtg_to_output_difference_width and rtg_to_output_difference_height do not exist, they may be estimated as 0.

When the value of rtg_rois_flag is 1, it may represent that Rols are signaled from a bitstream. In other words, the flag may represent whether Rols are signaled from a bitstream. If Rols are not signaled, a single Rol of the same size as an output picture may be inferred.

roi_size_len may designate the number of bits in which roi_size_x[i] and roi_size_y[i] syntax elements are signaled.

num_rois_len may designate the number of bits in which a num_rois syntax element is signaled.

num_rois may designate the number of Rols. The length of a num_rois syntax element may be a num_rois_len bit.

When rtg_rois_flag is the same as 0, num_rois may be inferred as 1.

When roi_scale_factor_flag is 1, it may represent that roi_scale_flag[i] is signaled. When roi_scale_factor_flag is 0, it may represent that roi_scale_factor[i] is not updated. In other words, when i>0, a previous value, roi_scale_factor[i−1], may be used and when i==0, 0 may be used.

roi_scale_factor[i] may designate the scale factor index of an Rol with index i. When roi_scale_factor[0] is not decoded, it may be estimated as 0. When roi_scale_factor[i] is not decoded and i is greater than 0, it may be estimated as roi_scale_factor[i−1].

$$Variable RtgOutputImageSizeWidth = rtg\_image \_size \_width + rtg\_to \_output \_difference \_width .$$

$$Variable RtgOutputImageSizeHeight = rtg\_image \_size \_height + rtg\_to \_output \_difference \_height .$$

$$Variable RoiPosLen = RequiredNumOfBitsForValue$$

$$( Max ( RtgOutputImageSizeWidth , RtgOutputImageSizeHeight ) ) .$$

roi_pos_x[i] may designate the horizontal position of an Rol with index i in an original image in a pixel unit.

The length of an roi_pos_x syntax element may be an RoiPosLen bit. When rtg_rois_flag is the same as 0, rois_pos_x[0] may be inferred as 0.

roi_pos_y[i] may designate the vertical position of an Rol with index i in an original image in a pixel unit.

The length of an roi_pos_y syntax element may be an RoiPosLen bit. When rtg_rois_flag is the same as 0, rois_pos_y[0] may be inferred as 0.

roi_size_x[i] may designate the width of an Rol with index i in an original image in a pixel unit. The length of a syntax element roi_size_y may be an roi_size_len bit. When rtg_rois_flag is the same as 0, rois_size_x[0] may be inferred to be the same as RtgOutputImageSizeWidth.

roi_size_y[i] may designate the height of Rol index i in an original image in a pixel unit. The length of a syntax element roi_size_x may be an roi_size_len bit. When rtg_rois_flag is the same as 0, rois_size_x[0] may be inferred to be the same as RtgOutputImageSizeHeight.

Resolution retargeted within CLVS must not be changed and original resolution may also not be changed.

A sequence may be divided by the syntax element of an internal decoder. When HEVC or VVC is used as an internal decoder, a new sequence may start when an SPS parameter setting signal is transmitted.

A retargeting_parameters( ) syntax element may be used multiple times within CLVS for the following purpose.
Provide an arbitrary access point to CLVS
Change the position of an Rol

The data of a ‘retargeting_parameters( )’ syntax element may be valid (activated) from the next consecutive decoding frame until the end of the next ‘retargeting_parameters( )’ syntax element.

‘Next consecutive’ may be interpreted as meaning after a frame to which ‘retargeting_parameters( )’ is connected. In addition, the range of ‘decoding’ may be the output of an internal codec. In addition, since retargeting occurs outside an internal codec and an internal decoder outputs internally decoded images in an output order, the ‘next’ may be interpreted as ‘next in an output order’.

A variable RtgOutputCoordsX[num_rois*2+2] may be defined as follows.
RtgOutputCoordsX[0] may be set as 0.
RtgOutputCoordsX[1] may be set to be the same as RtgOutputImageSizeWidth.
For i in the range of 0 to num_rois-1, RtgOutputCoordsX[i*2+2] may be the same as (roi_pos_x[i]>>1)<<1.
For i in the range of 0 to num_rois-1, RtgOutputCoordsX[i*2+3] may be the same as ((roi_pos_x[i]+roi_size_x[i])>>1+1)<<1. A horizontal x-coordinate RtgOutputCoordsX may be aligned in an ascending order without redundancy. A variable CoordsXNum may be the same as the number of unique values in an RtgOutputCoordsX list. Alternatively, a variable xCoordsNum may be the same as the number of unique values in an RtgOutputCoordsX list.

Variable RtgOutputCoordsY[num_rois*2+2] may be defined as follows.
RtgOutputCoordsY[0] may be set as 0.
RtgOutputCoordsY[1] may be set to be the same as RtgOutputImageSizeHeight.
For i in the range of 0 to num_rois-1, RtgOutputCoordsY[i*2+2] may be the same as (roi_pos_y[i]>>1)<<1.—For i in the range of 0 to num_rois-1, RtgOutputCoordsY[i*2+3] may be the same as ((roi_pos_y[i]+roi_size_y[i]+1)>>1)<<1.

A vertical y-coordinate (RtgOutputCoordsY) may be aligned in an ascending order without redundancy. A variable CoordsYNum may be the same as the number of unique values in an RtgOutputCoordsY list.

A variable RtgOutputSizeX[i] may be defined as follows for a range from 0 to CoordsXNum-2 (inclusive).
RtgOutputSizeX[i] may be set to be the same as RtgOutputCoordsX[i+1]-RtgOutputCoordsX[i].

A variable RtgOutputSizeY[i] may be defined as follows for a range from 0 to CoordsYNum-2 (inclusive).
RtgOutputSizeY[i] may be set to be the same as RtgOutputCoordsY[i+1]-RtgOutputCoordsY[i].

A variable ScaleFactorIndex [CoordsYNum-1, CoordsXNum-1] may be initialized as follows.
When yIdx is in the range from 0 to CoordsYNum-2 and xIdx is in the range from 0 to CoordsxNum-2, the following steps may be applied in order.
ScaleFactorIndex[yIdx][xIdx]=15.
For r in the range 0 to num_rois-1 inclusive, the following applies:
if (roi_pos_x[r]<=RtgOutputCoordsX[xIdx]) and (roi_pos_y[r]<=RtgOutputCoordsY[yIdx]) and (roi_pos_x[r]+roi_size_x[r]>=RtgOutputCoordsX[xIdx+1]) and (roi_pos_y[r]+roi_size_y[r]>=RtgOutputCoordsY[yIdx+1]) then

ScaleFactorIndex[yIdx][xIdx]=Min (ScaleFactorIndex[yIdx][xIdx], roi_scale_factor[r]).

FIG. 13 illustrates an example of the index of an Rol scaling factor for a numerator and a denominator.

A scale factor numerator and denominator used to derive a variable used to perform scaling in picture retargeting may be defined as ScaleFactorNominator and ScaleFactorDenominator, as shown in Table 1 (FIG. 13).

Since sfNom and sfDenom are an auxiliary variable used to express an integer decimal operation, the precision of an operation (e.g., a floating point) may not be an issue.

A variable RtgSizeX[CoordsXNum-1] is derived as follows, and xIdx may range from 0 to CoordsXNum-2.
minSf=ScaleFactorIndex[0][xIdx].
minSf is updated as follows, with yIdx in the range 1 to CoordsYNum-2 inclusive:
   minSf is set equal to Min(minSf, ScaleFactorIndex[yIdx][xIdx]).
   RtgSizeX[xIdx] is set equal to (((RtgOutputSizeX[xIdx]>>1)*ScaleFactorNominator[minSf])+ScaleFactorDenominator[minSf]-1)/ScaleFactorDenominator[minSf])<<1.

A variable RtgSizeY[CoordsYNum-1] is derived as follows, and yIdx may range from 0 to CoordsYNum-2.
minSf=ScaleFactorIndex[yIdx][0].
minSf is updated as follows, with xIdx in the range from 1 to CoordsXNum-2 inclusive:
   minSf=Min(minSf, ScaleFactorIndex[yIdx][xIdx]).
   RtgSizeY[yIdx]=(((RtgOutputSizeY[yIdx]>>1)*ScaleFactorNominator[minSf]+ScaleFactorDenominator[minSf]-1)/ScaleFactorDenominator[minSf])<<1.

The horizontal and vertical coordinate positions of a picture retargeted (to be reconfigured) may be calculated from a retargeted size.

A variable RtgCoordsXTemp[CoordsXNum] may be derived as follows.
RtgCoordsXTemp[0]=0.
RtgCoordsXTemp[xIdx+1]=RtgCoordsXTemp[xIdx]+RtgSizeX[xIdx] for xIdx in the range 0 to CoordsXNum-2 inclusive.

A variable RtgCoordsYTemp[CoordsYNum] may be derived as follows.
RtgCoordsYTemp[0]=0.
RtgCoordsYTemp[yIdx+1]=RtgCoordsYTemp[yIdx]+RtgSizeY[yIdx] for yIdx in the range 0 to CoordsYNum-2 inclusive.

Variables RtgCoordsX[CoordsXNum] and RtgSizeX[CoordsXNum-1] may be derived as follows.
RtgCoordsX[0]=0.
RtgCoordsX[xIdx+1]=RtgCoordsXTemp[xIdx+1]*RtgImageSizeX/RtgCoordsXTemp[CoordsXNum-1] for xIdx in the range 0 to CoordsXNum-2 inclusive.
RtgCoordsX[xIdx+1]=(RtgCoordsX[xIdx+1]>>1)<<1 for xIdx in the range 0 to CoordsXNum-1 inclusive.
RtgSizeX[xIdx]=RtgCoordsX[xIdx+1]-RtgCoordsX[xIdx].

Variables RtgCoordsY[CoordsYNum] and RtgSizeY[CoordsYNum-1] may be derived as follows.
RtgCoordsY[0]=0.
RtgCoordsY[yIdx]=RtgCoordsYTemp[yIdx+1]*RtgImageSizeY/RtgCoordsYTemp[CoordsYNum-1] for yIdx in the range to CoordsYNum-2 inclusive.
RtgCoordsY[yIdx+1]=(RtgCoordsY[yIdx+1]>>1)<<1 for yIdx in the range 0 to CoordsYNum-1 inclusive.
RtgSizeY[yIdx]=RtgCoordsY[yIdx+1]-RtgCoordsY[yIdx].

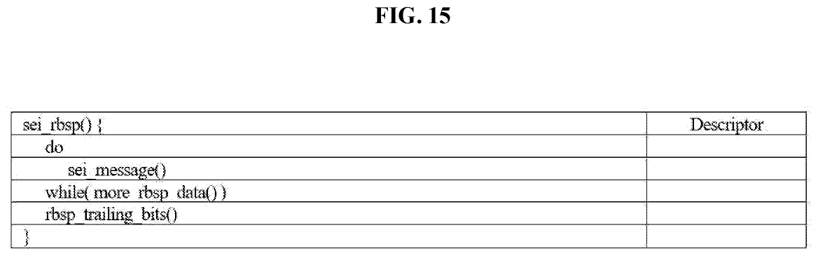

FIG. 14 illustrates an example of a bit depth parameter set RBSP syntax.

bps_vcm_parameter_set_id may provide an identifier for a bit depth parameter set for reference in other syntax elements.

When a bit depth_shift_luma value is 0, 1, 2, 3, 4, 5, 6 or 7, an input luma sample may be shifted to the left by 0, 1, 2, 3, 4, 5, 6 or 7 bits, respectively, during a bit depth shift process.

When a bit depth_shift_chroma value is 0, 1, 2, 3, 4, 5, 6 or 7, an input chroma sample may be shifted to the left by 0, 1, 2, 3, 4, 5, 6 or 7 bits, respectively, during a bit depth shift process.

The bitstream structure of a current WD may be complicated due to a large number of headers. To address this issue, a method for generating an NAL unit class in the NAL unit type format of VVC/HEVC may be proposed. A proposed NAL unit class table may require further discussion in a future subsequent meeting to define an NAL unit type.

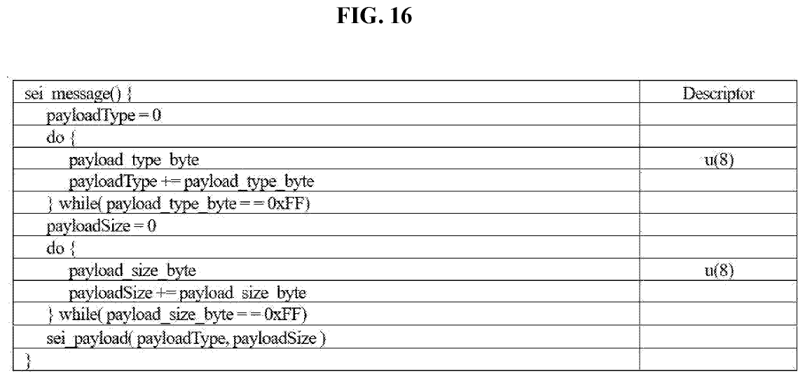

FIG. 15 illustrates an example of a supplemental enhancement information RBSP syntax.

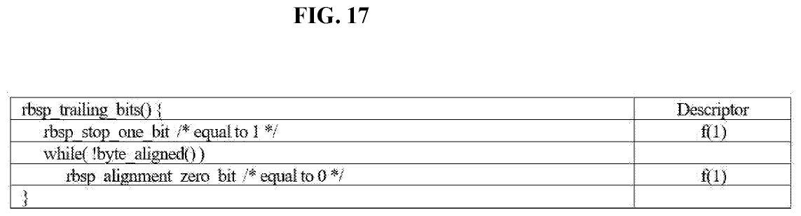

FIG. 16 illustrates an example of a supplemental enhancement information message syntax.

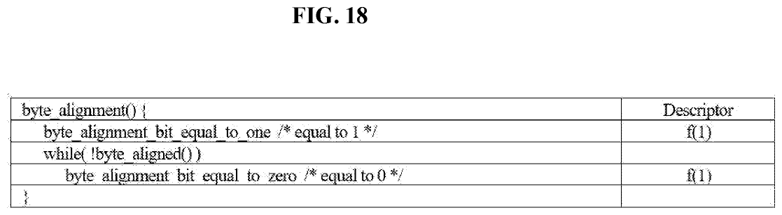

FIG. 17 illustrates an example of an RBSP trailing bits syntax.

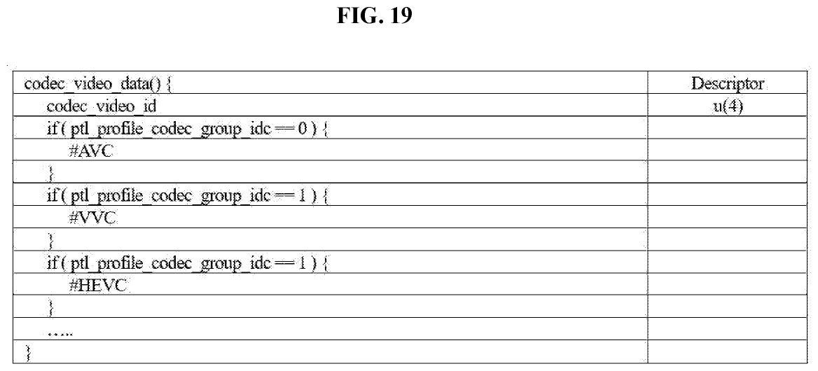

FIG. 18 illustrates an example of a byte alignment syntax.

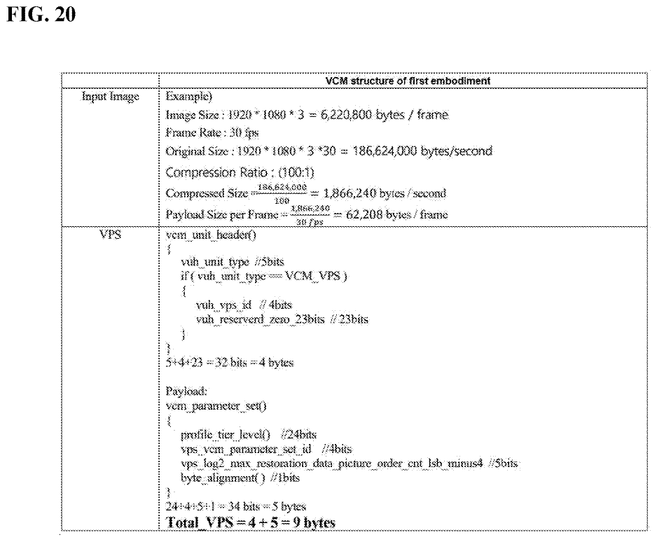

FIG. 19 illustrates an example of a codec video data syntax.

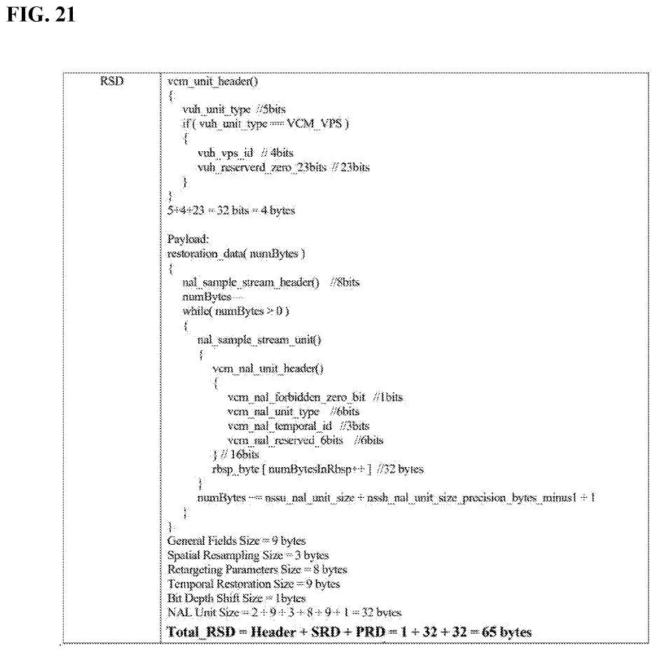

FIGS. 20 to 22 illustrate an example of the number of bytes of a bitstream structure in the first embodiment.

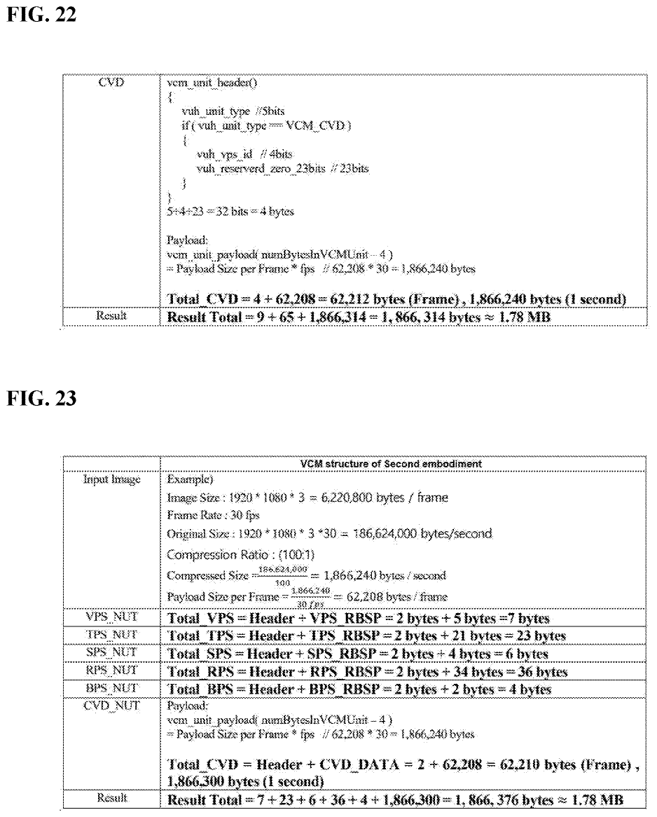

FIG. 23 illustrates an example of the number of bytes of a bitstream structure in the second embodiment.

In the NAL unit type class of the proposed second embodiment, parameters defined by SRD and PRD, which are the component of the RSD of a bitstream structure in the first embodiment, may be separated into time, space, an ROI and a bit depth. During this process, a redundant parameter may be removed from SRD and PRD and it may be substituted with a VCM NAL unit type, so an activation flag may be removed.

A name of syntax elements introduced in the above-described embodiments is just temporarily given to describe embodiments according to the present disclosure. Syntax elements may be named differently from what was proposed in the present disclosure.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as a FPGA, a GPU, other electronic device, or a combination thereof. At least some of functions or processes described in illustrative embodiments of the present disclosure may be implemented by a software and a software may be recorded in a recording medium. A component, a function and a process described in illustrative embodiments may be implemented by a combination of a hardware and a software.

A method according to an embodiment of the present disclosure may be implemented by a program which may be performed by a computer and the computer program may be recorded in a variety of recording media such as a magnetic Storage medium, an optical readout medium, a digital storage medium, etc.

A variety of technologies described in the present disclosure may be implemented by a digital electronic circuit, a computer hardware, a firmware, a software or a combination thereof. The technologies may be implemented by a computer program product, i.e., a computer program tangibly implemented on an information medium or a computer program processed by a computer program (e.g., a machine readable storage device (e.g.: a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and one or more processors of a digital computer. Generally, a processor receives an instruction and data in a read-only memory or a random access memory or both of them. A component of a computer may include at least one processor for executing an instruction and at least one memory device for storing an instruction and data. In addition, a computer may include one or more mass storage devices for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, and a ROM (Read Only Memory), a RAM (Random Access Memory), a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer and may include both a computer storage medium and a transmission medium.

The present disclosure includes detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in the form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from a claim and a spirit and a scope of its equivalent.

Accordingly, the present disclosure includes all other replacements, modifications and changes belonging to the following claim.

1. An image encoding method, comprising:
generating a bitstream by encoding an image output through a preprocessing process; and
transmitting the bitstream,
wherein the bitstream includes at least one network abstraction layer (NAL) unit, and
wherein a header of the NAL unit includes index information specifying a type of an NAL unit.

2. The method of claim 1, wherein:
the type of the NAL unit is a type of one NAL unit specified by the index information among types of a plurality of NAL units included in a pre-defined table.

3. The method of claim 2, wherein:
the types of the plurality of NAL units include a video parameter set (VPS), codec video data (CVD) and an end of bitstream (EOB).

4. The method of claim 3, wherein:
the types of the plurality of NAL units include at least one of a spatial parameter set (SPS), a temporal parameter set (TPS), an Rol parameter set (RPS) and a bit-depth parameter set (BPS).

5. The method of claim 4, wherein:
an NAL unit in which the type of the NAL unit is the SPS includes an SPS raw byte sequence payload (RBSP).

6. The method of claim 4, wherein:
an NAL unit in which the type of the NAL unit is the TPS includes a TPS raw byte sequence payload (RBSP).

7. The method of claim 6, wherein:
a syntax structure of the TPS RBSP does not include a flag for activating the TPS.

8. An image decoding method, comprising:
obtaining a decoded image by decoding a received bitstream; and
reconstructing an original image by postprocessing the decoded image through a postprocessing process,
wherein the bitstream includes at least one network abstraction layer (NAL) unit, and
wherein a header of the NAL unit includes index information specifying a type of an NAL unit.

9. The method of claim 8, wherein:
the type of the NAL unit is a type of one NAL unit specified by the index information among types of a plurality of NAL units included in a pre-defined table.

10. The method of claim 9, wherein:
the types of the plurality of NAL units include at least one of a spatial parameter set (SPS), a temporal parameter set (TPS), an Rol parameter set (RPS) and a bit-depth parameter set (BPS).

11. The method of claim 10, wherein:
an NAL unit in which the type of the NAL unit is the SPS includes an SPS raw byte sequence payload (RBSP).

12. The method of claim 10, wherein:
an NAL unit in which the type of the NAL unit is the TPS includes a TPS raw byte sequence payload (RBSP).

13. The method of claim 12, wherein:
a syntax structure of the TPS RBSP does not include a flag for activating the TPS.

14. A non-transitory computer-readable recording medium for storing a bitstream generated by an image encoding method, wherein the image encoding method comprises:
generating the bitstream by encoding an image output through a preprocessing process; and
transmitting the bitstream,
wherein the bitstream includes at least one network abstraction layer (NAL) unit, and
wherein a header of the NAL unit includes index information specifying a type of an NAL unit.
